(19) United States
(12) Patent Application Publication
(10) Pub. No.: US 2008/0166944 A1
(43) Pub. Date: Jul. 10, 2008

(54) Novelty Toy With Magnetically Reactive Synthetic Fur and Its Associated Method of Manufacture

(76) Inventor: Webb T. Nelson, Woodinville, WA (US)

Correspondence Address: LAMORTE & ASSOCIATES P.C., P.O. BOX 434, YARDLEY, PA, 19067, US

(21) Appl. No.: 11/969,289

(22) Filed: Jan. 4, 2008

Related U.S. Application Data
(60) Provisional application No. 60/878,459, filed on Jan. 4, 2007.

(51) Int. Cl. A63H 33/26; A63H 3/02; B32B 27/00; B29D 31/00; A63H 3/36

(52) U.S. Cl. 446/129; 446/369; 446/385; 428/394; 264/243

(57) ABSTRACT

Magnetically reactive synthetic fur and plush toy assembly that contains such synthetic fur. The synthetic fur is made from a mixture of a polymer plastic and metal dust that is extruded into stands. The metal dust is iron or another alloy that is attracted to a magnet. Since the strands contain metal dust, the strands physically move when brought into proximity of a magnet. To increase the movement of the strands, the metal particles contained within the strands can themselves be magnetized. The synthetic fur is used to create a plush toy or similar item. The plush toy can be packaged with a secondary object that contains a magnet. In this way, when the secondary object is moved along the toy, the synthetic fur reacts by moving in reaction to the passing magnetic field.

### RELATED APPLICATIONS

This patent application claims priority of co-pending U.S. Provisional Patent Application No. 60/878,459, filed Jan. 4, 2007 and entitled Novelty Toy With Magnetically Reactive Synthetic Fur And Its Associated Method Of Manufacture.

### BACKGROUND OF THE INVENTION

1. Field of Invention

In general, the present invention relates to synthetic fur used on plush toys and the methods used to make such synthetic fur. More particularly, the present invention relates to the composition of the synthetic fur and synthetic fur having metallic additives.

2. Prior Art Description

In the toy industry, toys made from fabric and stuffing are generally referred to as plush toys. Plush toys include stuffed animals, rag dolls, and the like. In the creation of plush toys, especially stuffed animals, it is not unusual to use a synthetic fur material. Often the exterior of the plush toy is made from swatches of synthetic fur. Other times, patches of synthetic fur are sewn onto the exterior of the plush toy.

In the 19^{th} century, real animal fur was often used to create plush toys. In the 20^{th} century, real fur gave way to synthetic fur. Today, most all fur used on plush toys is a polymer based synthetic fur. Such fur is made from fine strands of polymer plastics, such as nylon, polypropylene, polyester and the like.

Over the years, many secondary materials have been added to the polymers used to make synthetic fur. Such additives include color additives, plasticizers and various oils that make the synthetic fur smoother and shinier.

Although the color and texture of synthetic fur has been varied in many ways, synthetic fur still remains a passive element on a plush toy. That is, the synthetic fur may have an aesthetic look and a pleasant feel, but the fur is an inanimate part of the toy.

The present invention provides synthetic fur that is an active part of the toy. The synthetic fur is capable of moving and becoming an animated part of the toy, thereby increasing the play value of the toy. The details of the present invention synthetic fur are described and claimed below.

### SUMMARY OF THE INVENTION

The present invention is for magnetically reactive synthetic fur and for plush toy assemblies that contain such synthetic fur. The synthetic fur is made from a mixture of a polymer plastic and metal dust that is extruded into stands. The metal dust is iron or another alloy that is attracted to a magnet. The strands are used to create synthetic fur in a conventional manner.

Since the strands contain metal dust, the strands physically move when brought into close proximity of a magnet. To increase the movement of the strands, the metal particles contained within the strands can themselves be magnetized.

The synthetic fur is used to create a plush toy or similar item. The plush toy can be packaged with a secondary object that contains a magnet. In this way, when the secondary object is moved along the toy, the synthetic fur reacts by moving in reaction to the passing magnetic field.

### BRIEF DESCRIPTION OF THE DRAWINGS

For a better understanding of the present invention, reference is made to the following description of an exemplary embodiment thereof, considered in conjunction with the accompanying drawings, in which:

FIG. 1 is a perspective view of an exemplary embodiment of a plush toy assembly containing synthetic fur; and

FIG. 2 is a schematic showing an exemplary method of manufacturing strands for synthetic fur.

### DETAILED DESCRIPTION OF THE DRAWINGS

Although the synthetic fur of the present invention can be used as a component of many consumer products, such as furry slippers, earmuffs, clothing and the like, the synthetic fur of the present invention is especially well suited for making plush toys. Accordingly, an exemplary embodiment of a plush toy has been selected to illustrate the present invention. The selected embodiment is only one example and should not be considered a limitation on the scope of the claims.

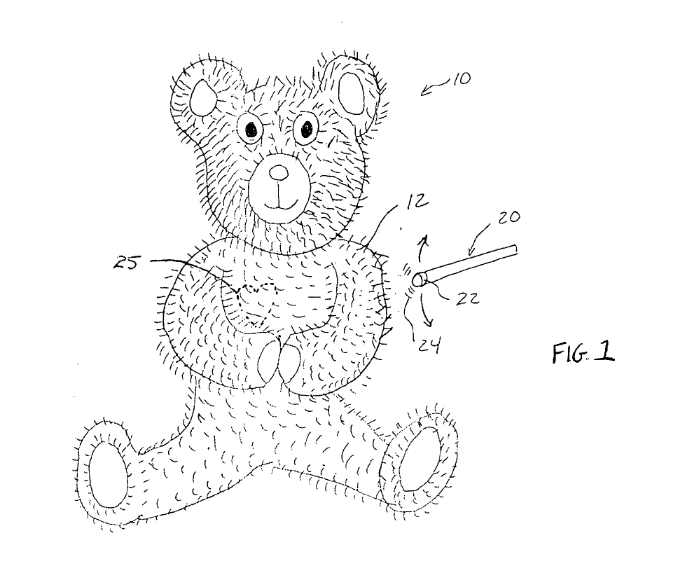

Referring to FIG. 1, a plush toy 10 is shown in accordance with the present invention. The illustrated plush toy is a stuffed bear character. The stuffed bear character is intended to be exemplary of any and all stuffed toy characters.

The plush toy 10 is made at least in part from synthetic fur 12. The synthetic fur 12 is made from exposed strands 30 of material that are woven to produce the structure of synthetic fur. Accordingly, many thousands of strands 30 of the synthetic fur 12 are exposed on the exterior of the plush toy 10. The strands 30 of synthetic fur 12 are preferably long, having a length of at least one centimeter, so that the strands 30 of synthetic fur 12 fall loosely about the plush toy 10.

The strands 30 of synthetic fur 12 that are used in the making of the plush toy 10 are a mixture of a polymer and a magnetically active material. In the synthetic fur 12, metal dust is mixed with the polymer material that is used to create the synthetic fur 12. Consequently, each strand 30 of synthetic fur 12 contains a small volume of the added metal. The metal added to the synthetic fur 12 is either itself magnetic or contains iron so as to be ferro-magnetic. In this manner, the synthetic fur 12 becomes affected by the presence of magnetic fields.

A wand, bracelet, ring, or other external accessory 20 is packaged with the plush toy 10. The external accessory 20 contains a magnet 22 and, therefore, emits a magnetic field 24. When synthetic fur 12 comes within the influence of the magnetic field 24, the magnetic field 24 causes physical movement in the synthetic fur 12. The synthetic fur 12 will therefore ripple as the external accessory 20 is moved around the outside of the plush toy 10.

The individual strands 30 of the synthetic fur 12 are attracted to the magnet 22 in the external accessory 20. Accordingly, if the external accessory 20 is brought into contact with the synthetic fur 12, the strands 30 of the synthetic fur 12 will gather to the magnet 22. The external accessory 20 can therefore be used to selectively move the synthetic fur 12, exposing images, words, or other indicia 25 that may be printed on the plush toy 10 under the synthetic fur 12.

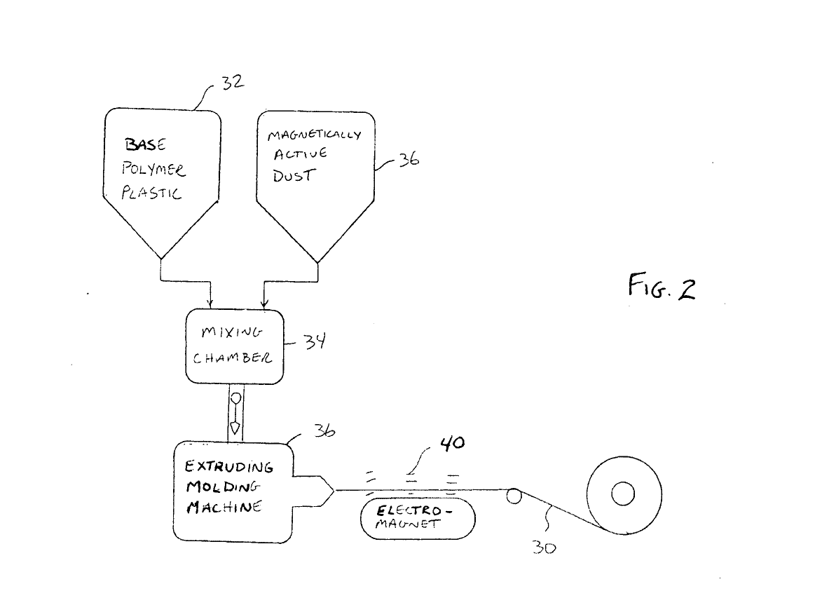

Referring to FIG. 2, it can be seen that the strands 30 of synthetic fur 12 (FIG. 1) are made using an extrusion molding process. A base polymer plastic 32 is provided. The base polymer plastic 32 can be polyester, nylon, polypropylene or the like. The base polymer plastic 32 is heated into molten form within a mixing chamber 34. Magnetically active dust 36, in the form of iron dust or iron alloy dust, is added into the mixing chamber 34 so that the magnetically active dust 36 makes up between one percent and ten percent of the molten composition by weight. The molten composition is then fed into an extruded molding machine 38 where it is extruded into a strand 30 in a conventional manner.

Once cured, the strand 30 is rolled onto spools. The strands can then be woven onto sheets of synthetic fur using conventional processes.

Prior to the strands 30 being used to make synthetic fur, the strands 30 can be subjected to a strong electro-magnetic field 40. The electro-magnetic field 40 magnetizes the metal contained within the strands 30. Each strand 30, therefore, contains magnetized metal particles and emits its own magnetic field. By magnetizing the strands 30 used to create the synthetic fur, the reaction to the synthetic fur to the magnetic external accessory can be increased. The metal particles, if magnetized, must be magnetized after the molding process due to the high temperatures used during the molding process.

It will be understood that many different types of plush toys and other novelties can be created using the synthetic fur described. The selected embodiment is merely exemplary. All such variations, modifications, and alternate embodiments are intended to be included within the scope of the present invention as defined by the claims.

What is claimed is:

1. A toy assembly;
a character made at least in part from synthetic fur, wherein said synthetic fur contains individual strands that contain magnetically active material;
an accessory, external and separate from said character that contains a magnet powerful enough to attract said magnetically active material in said strands of said synthetic fur when brought into proximity of said synthetic fur, thereby causing movement in said synthetic fur.

2. The assembly according to claim 1, wherein said magnetically active material includes metal dust.

3. The assembly according to claim 2, wherein said metal dust is magnetized.

4. The assembly according to claim 2, wherein said synthetic fur is molded from a polymer plastic mixed with said metal dust.

5. The assembly according to claim 1, wherein said synthetic fur has strands with a length greater than one centimeter.

6. The assembly according to claim 1, wherein said character is a plush toy having an exterior, made at least in part, from said synthetic fur.

7. Synthetic fur comprising:
a plurality of individual strands, wherein each of said strands is comprised of a mixture of a polymer and a magnetically active metal dust in a concentration sufficient to cause each of said strands to be physically attracted to an external magnet brought into proximity of said synthetic fur.

8. The synthetic fur according to claim 7, wherein said magnetically active metal dust contains iron.

9. The synthetic fur according to claim 7, wherein said magnetically active metal dust is magnetized within each of said strands.

10. The synthetic fur according to claim 7, wherein said magnetically active metal dust is mixed with said polymer in a concentration of between one percent and ten percent by weight.

11. A method of manufacturing synthetic fur, comprising the steps of:
creating a molding composition by mixing a molten plastic polymer with metal dust that is reactive to a magnetic field;
molding strands from said molding composition;
forming synthetic fur from said strands, wherein said synthetic fur physically moves when brought into proximity of a magnet.

12. The method according to claim 11, wherein said metal dust includes iron.

13. The method according to claim 11, further including the step of magnetizing said metal dust in said strands.

14. The method according to claim 13, wherein said step of magnetizing said metal dust includes exposing said strands to a magnetic field strong enough to magnetize said metal dust present in said strands.
